(19) United States
(12) Patent Application Publication
(10) Pub. No.: US 2024/0333031 A1
(43) Pub. Date: Oct. 3, 2024

(54) WIRELESS CHARGING SYSTEM AND ITS MOBILE CARRIER

(71) Applicant: SUPER GROUP SEMICONDUCTOR CO., LTD., Hsinchu County (TW)

(72) Inventor: Jen-Jun SU, Hsinchu County (TW)

(21) Appl. No.: 18/334,354

(22) Filed: Jun. 13, 2023

(30) Foreign Application Priority Data
Mar. 30, 2023 (TW) 112202932

(51) Int. Cl. H02J 50/00; B60L 53/12; B60L 53/34; H02J 50/10

(52) U.S. Cl. CPC H02J 50/005; B60L 53/12; B60L 53/34; H02J 50/10

(57) ABSTRACT

A mobile carrier includes a carrier body, a power storage device and a power receiving module. The carrier body is formed with a recessed portion and an opening connected to the recessed portion. The power storage device is disposed within the carrier body. The power receiving module includes a coil device. The coil device is electrically connected to the power storage device and received within the recessed portion. A gap is defined between the coil device and the opening.

### RELATED APPLICATIONS

This application claims priority to Taiwan Application Serial Number 112202932, filed on Mar. 30, 2023, which is herein incorporated by reference in its entirety.

### BACKGROUND

### Field of Disclosure

The present disclosure relates to a charging system. More particularly, the present disclosure relates to a wireless charging system capable of providing wireless charging and mobile carrier of the wireless charging system.

### Description of Related Art

Generally, when an electric vehicle is parked at a charging station, a receiving coil of the electric vehicle is only needed to be adjacent to a power-supply coil of the charging station rather than being plugged on the electric vehicle, so that wireless induction can be generated between the receiving coil and the power-supply coil so as to provide the required electric power for the electric vehicle.

However, the receiving coil being installed on the electric vehicle may be exposed outwards from the external surface of the electric vehicle so as to hinder the appearance of the vehicle body of electric vehicle. Therefore, not only causing the risk of theft and hindering the appearance, but also affecting the user's purchase intention.

Therefore, the above-mentioned technology apparently is still with inconvenience and defects and needed to be further develop. Hence, how to develop a solution to improve the foregoing deficiencies and inconvenience is an important issue that relevant persons engaged in the industry are currently unable to delay.

### SUMMARY

One aspect of the present disclosure is to provide a wireless charging system and its mobile carrier for solving the difficulties mentioned above in the prior art.

In one embodiment of the present disclosure, a mobile carrier includes a carrier body, a power storage device and a power receiving module. The carrier body is formed with a recessed portion and an opening being in communication with to the recessed portion. The power storage device is disposed within the carrier body. The power receiving module includes a first coil device electrically connected to the power storage device and received within the recessed portion, and a gap is defined between the first coil device and the opening.

According to one or more embodiments of the present disclosure, in the mobile carrier, the carrier body includes a case, and the recessed portion is recessed on the case, and the opening is arranged on one side of the recessed portion that is connected to the case.

According to one or more embodiments of the present disclosure, the mobile carrier further includes a lid element. The lid element includes a lid plate covering the opening.

According to one or more embodiments of the present disclosure, in the mobile carrier, the lid element further includes a linkage portion that is connected to the lid plate. The lid plate movably covers the opening. The carrier body further includes a first motor device connected to the linkage portion so as to move the lid plate through the linkage portion.

According to one or more embodiments of the present disclosure, in the mobile carrier, the carrier body further includes at least one rail, at least one bracket and a second motor device. The rail is fixed within the recessed portion. The bracket is slidably disposed on the rail and linearly sliding through the opening. The second motor device is fixedly connected to the bracket, and has a transmission shaft of the second motor device is connected to the first coil device for rotating the first coil device.

According to one or more embodiments of the present disclosure, in the mobile carrier, the first coil device includes a coil module and a coil housing received within the recessed portion and formed with an accommodating recess for accommodating the coil module.

According to one or more embodiments of the present disclosure, the mobile carrier further includes at least one stopper. The stopper is disposed on the carrier body. The first coil device further includes at least one first shaft-received portion and at least one second shaft-received portion. The first shaft-received portion and the second shaft-received portion are commonly disposed on a same surface. When the first coil device is disposed in the recessed portion, an axial line of the coil module and a gravity direction are parallel to each other. The carrier body further includes at least one rail, at least one bracket, at least one L-shaped linkage element and a sliding element. The rail is fixed within the recessed portion. The bracket is slidably disposed on the rail and pivotally connected to the first shaft-received portion through a first pivot, and the bracket is formed with an elongated hole. The L-shaped linkage element includes a first section and a second section which are intersected each other. The first section is pivotally connected to the second shaft-received portion through a second pivot. The second section extends towards the second shaft-received portion from the first section. The sliding element is disposed on the second section of the L-shaped linkage element and slidably limited within the elongated hole. When the bracket pushes a part of the first coil device out of the opening through the first pivot, the L-shaped linkage element is stopped by the stopper. When the bracket continues to push the first coil device, the first coil device uses the second pivot as a fulcrum to rotate the first coil device out of the recessed portion from the opening, so that the axial line of the coil module and the gravity direction are orthogonal to each other.

According to one or more embodiments of the present disclosure, in the mobile carrier, the first coil device is electrically connected to the power storage device through a power cord penetrating through the recessed portion.

According to one or more embodiments of the present disclosure, in the mobile carrier, an opening direction of the opening and a gravity direction are orthogonal to each other.

In one embodiment of the present disclosure, a wireless charging system includes a cover, a power transmission module and the mobile carrier mentioned above. The cover is formed with a second recess at one surface of the cover. The power transmission module includes a power supply device and a second coil device disposed within the second recess and electrically connected to the power supply device. The recessed portion of the mobile carrier is formed with a first recess. When the cover docks to the recessed portion, an induction space is defined between the recessed portion and the second recess of the cover, and the first coil device and the second coil device are faced and induced to each other in the induction space.

According to one or more embodiments of the present disclosure, in the wireless charging system, when the cover is in contact with the carrier body to cover the opening, the first recess and the second recess of the cover are in communication with each other for integrating the induction space.

According to one or more embodiments of the present disclosure, in the wireless charging system, the first recess is formed with a trough bottom therein, and the trough bottom is in a planar shape. When the cover docks to the recessed portion, the cover is disposed within the first recess, the cover is in contact with the trough bottom of the first recess and covers the first coil device.

According to one or more embodiments of the present disclosure, in the wireless charging system, the first recess is formed with a trough bottom and an inner sloped surface adjoined to the trough bottom. When the cover docks to the recessed portion, one part of the cover is disposed within the first recess, and the cover is in contact with the inner sloped surface of the first recess.

According to one or more embodiments of the present disclosure, in the wireless charging system, the power receiving module further includes another cover capable of loading the first coil device and disposed within the first recess. The second recess is formed with a trough bottom and an inner sloped surface adjoined to the trough bottom. When the cover docks to the recessed portion, one part of the cover is disposed within the first recess, one part of the another cover is disposed within the second recess, and the another cover is in contact with the inner sloped surface of the second recess.

According to one or more embodiments of the present disclosure, in the wireless charging system, the recessed portion and the cover are collectively integrated into a shielding chamber containing the induction space therein.

Thus, through the construction of the embodiments above, the disclosure is able to accomplish a coil device being installed without affecting the appearance of the vehicle body of electric vehicle so as to reduce the risk of theft and hindering the appearance, thereby increasing the user's purchase intention.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 is a schematic view of a wireless charging system according to one embodiment of the present disclosure.

FIG. 2 is a partially schematic view of the power receiving module and the power transmission module which are docked to each other in FIG. 1.

FIG. 3A is a perspective view shown a power receiving module and a first cover according to one embodiment of the present disclosure.

FIG. 3B is a schematic side view of the power receiving module of FIG. 3A docked to a power transmission module.

FIG. 4 is a partially schematic view of a mobile carrier according to one embodiment of the present disclosure.

FIG. 5A and FIG. 5B are perspective views respectively shown a first cover containing a power receiving module in different states according to one embodiment of the present disclosure.

FIG. 6A is a schematic view shown a power receiving module and a power transmission module which are docked to each other according to one embodiment of the present disclosure.

FIG. 6B is a schematic view shown a power receiving module and a power transmission module which are docked to each other according to one embodiment of the present disclosure.

FIG. 6C is a schematic view shown a power receiving module and a power transmission module which are docked to each other according to one embodiment of the present disclosure.

FIG. 7A to FIG. 7C are continuous operational schematic views of a mobile carrier according to one embodiment of the present disclosure.

FIG. 8 is a perspective view shown a power receiving module and a first cover according to one embodiment of the present disclosure.

FIG. 9 is a partially disassembled view of the power receiving module and the first cover in FIG. 8.

FIG. 10A to FIG. 10D are continuous operational schematic views of the power receiving module of FIG. 9.

### DESCRIPTION OF THE EMBODIMENTS

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

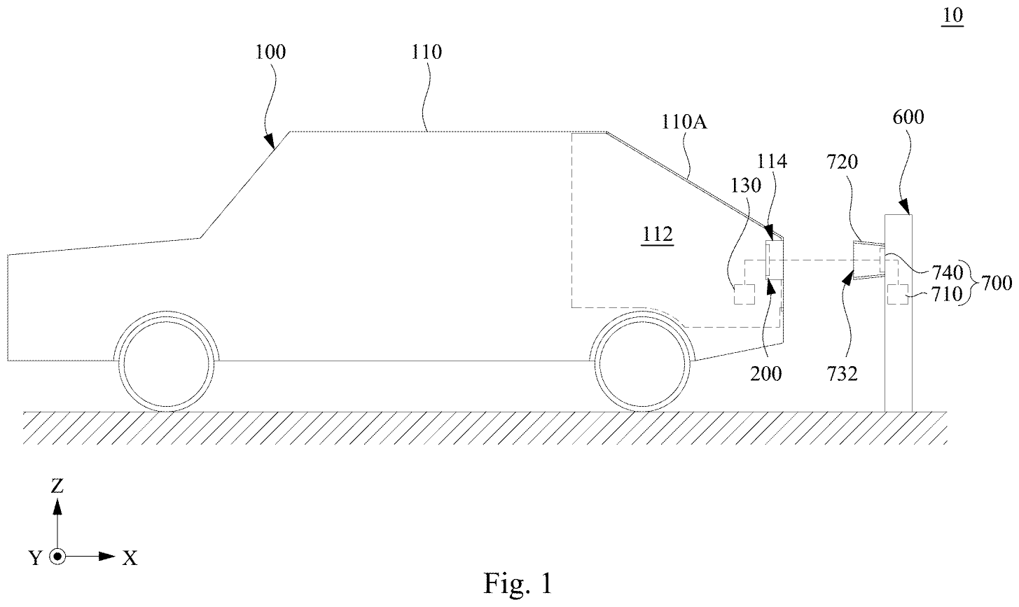

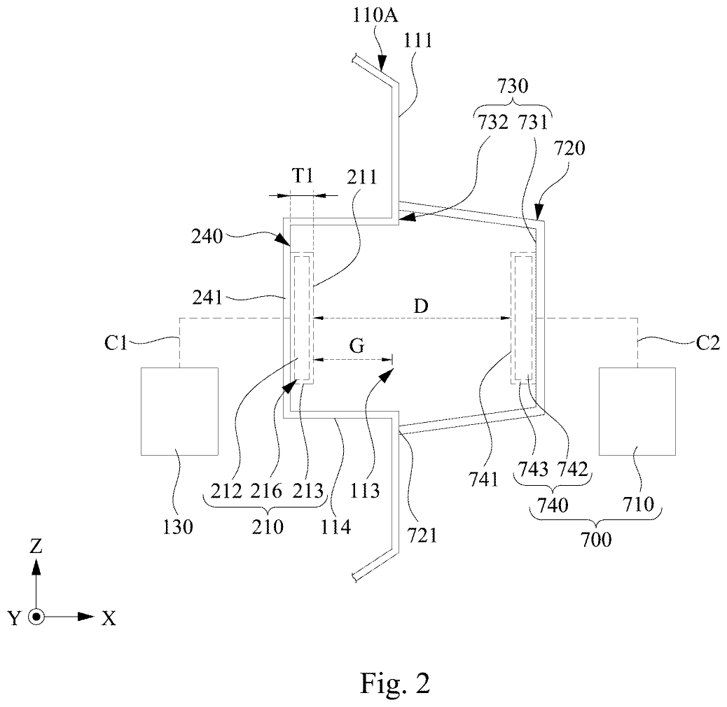

Reference is now made to FIG. 1 and FIG. 2, in which FIG. 1 is a schematic view of a wireless charging system 10 according to one embodiment of the present disclosure. FIG. 2 is a partially schematic view of the power receiving module 200 and the power transmission module 700 which are docked to each other in FIG. 1. As shown in FIG. 1 and FIG. 2, in this embodiment, the wireless charging system 10 includes a mobile carrier 100 and a charging station 600. The mobile carrier 100 includes a carrier body 110, a power storage device 130 and a power receiving module 200. The carrier body 110 is formed with a recessed portion 114 and an opening 113 being in communication with to the recessed portion 114. The power storage device 130 is disposed within the carrier body 110. The power receiving module 200 includes a first coil device 210 electrically connected to the power storage device 130 and received within the recessed portion 114, and a gap G is defined between the first coil device 210 and the opening 113 of the carrier body 110.

In the embodiment, the carrier body 110 includes a case 110A. The recessed portion 114 is recessed on an outer surface 111 of the case 110A, and the aforementioned opening 113 is disposed on one side of the recessed portion 114 that is connected to the case 110A, and an opening direction (e.g., X axis) of the opening 113 is orthogonal to a direction of gravity (e.g., Z axis).

The recessed portion 114 is formed with a first recess 240 therein, and the first recess 240 includes a trough bottom 241. The trough bottom 241 and the opening 113 are opposite to each other. The first coil device 210 is located within the first recess 240, fixed on the trough bottom 241 of the first recess 240, and a front surface (referred to an induction surface 211, hereinafter) of the first coil device 210 facing towards the opening 113. Thus, a current arrangement direction of the first coil device 210 is called as a horizontally situated state hereinafter.

The charging station 600 is provided with a power transmission module 700 and a second cover 720. The power transmission module 700 includes a power supply device 710 and a second coil device 740. One surface 721 of the second cover 720 is formed with a second recess 730. The power supply device 710 is located outside the second recess 730. The second coil device 740 is disposed within the second recess 730 and electrically connected to the power supply device 710. More specifically, the second recess 730 includes a trough bottom 731 and a notch 732 which are opposite to each other. The second coil device 740 is located at the trough bottom 731 of the second recess 730, and a front surface (i.e., referred to an induction surface 741, hereinafter) of the second coil device 740 facing towards the notch 732 of the second recess 730. Therefore, the current arrangement direction of the second coil device 740 is in the above-mentioned horizontally situated state.

Furthermore, the power storage device 130 is fixed within an inner space 112 of the case 110A, and the first coil device 210 (e.g., first coil module 212) is electrically connected to the power storage device 130 through a power line C1 passing through the recessed portion 114. The second coil device 740 is electrically connected to the power supply device 710 through a power line C2 passing through the second cover 720.

In this way, as shown in FIG. 1 and FIG. 2, when the mobile carrier 100 moves to the charging station 600 so that the power receiving module 200 docks to the power transmission module 700, an induction space is defined between the recessed portion 114 and second recess 730 of the second cover 720, and the first coil device 210 and the second coil device 740 are faced and induced to each other in the induction space so that the first coil device 210 generates and sends power to the power storage device 130, thereby charging the power storage device 130.

More specifically, in this embodiment, the aforementioned surface 721 of the second cover 720 contacts the outer surface 111 of the case 110A, that is the second cover 720 does not protrude into the recessed portion 114. All of the first recess 240 and all of the second recess 730 are in communication with each other so as to form the above-mentioned induction space.

More specifically, in the embodiment, the first coil device 210 includes a first coil module 212 and a first coil housing 213. The first coil housing 213 is disposed at the trough bottom 241 of the first recess 240. The first coil housing 213 is formed with an accommodating recess 216 for receiving the first coil module 212. The first coil module 212 is provided with a first axis line (e.g., X axis) passing through the induction surface 211 of the first coil device 210, and parallel to the opening direction of the opening 113 (e.g., X axis). At this moment, the first coil device 210 is in the horizontally situated state. The second coil device 740 includes a second coil module 742 and a second coil housing 743. The second coil module 742 is received within the second coil housing 743, and the second coil housing 743 is located at the trough bottom 731 of the second recess 730, for example. The second coil module 742 is provided with a second axis line (e.g., X axis) passing through the induction surface 741 of the second coil device 740, and parallel to the opening direction of the opening 113 (e.g., X axis). At this moment, the second coil device 740 is in the horizontally situated state. However, the present disclosure is not limited thereto, in other embodiments, each of the above-mentioned first/second coil devices 210 and 740 may only have a coil module without being loaded by any coil housing.

It is noted that the first coil module 212 and the second coil module 742 are respectively in a spiral shape or a concentric circular shape for respectively surrounding to form a coil opening with the first/second axis lines. The first axis line may also be an axis line of the first coil device 210, and the second axis line may also be an axis line of the second coil device 740.

In addition, in this embodiment, a shortest distance D (e.g., about 10-20 cm) is defined between the second coil device 740 and the first coil device 210, and the shortest distance D is several times the thickness T1 of the first coil device 210. For example, the thickness T1 of the first coil device 210 is about 2 cm, and the gap G between the first coil device 210 and the opening 113 is about 8 cm. Therefore, in terms of magnetic resonance charging technology, a certain distance (e.g., about 4 cm or more) is needed to be kept between the second coil device 740 and the first coil device 210 to provide better charging efficiency and avoid decreasing charging efficiency due to excessive proximity.

In this embodiment, the carrier body 110 is an electric vehicle (e.g., a four-wheel electric vehicle), however, the disclosure is not limited thereto, and in other embodiments, the carrier body 110 may also be a single/double seat electric vehicle or an Unmanned Aerial Vehicles (UAV). In this embodiment, the power receiving module 200 is embedded in the rear of the electric vehicle (e.g., rear compartment), however, the disclosure is not limited thereto, and in other embodiments, the power receiving module 200 may also be fixed outside the rear compartment (e.g., the side of the vehicle body). In this embodiment, the power storage device 130 is, for example, a battery device, however, the disclosure is not limited thereto.

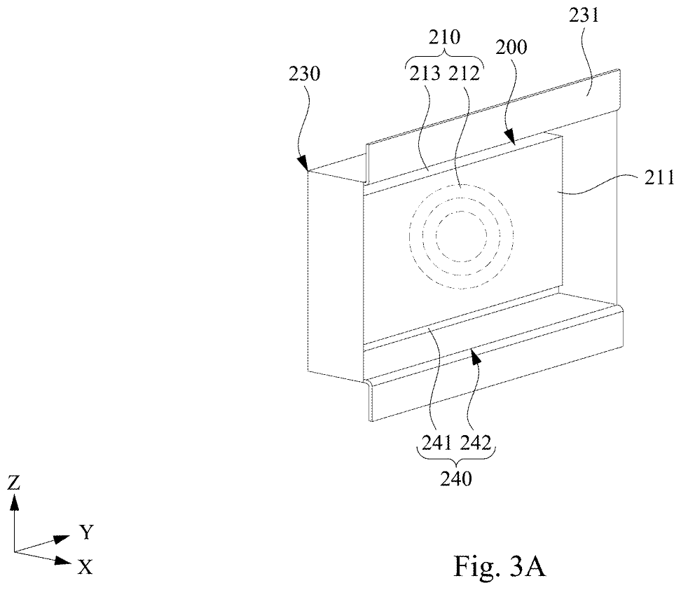

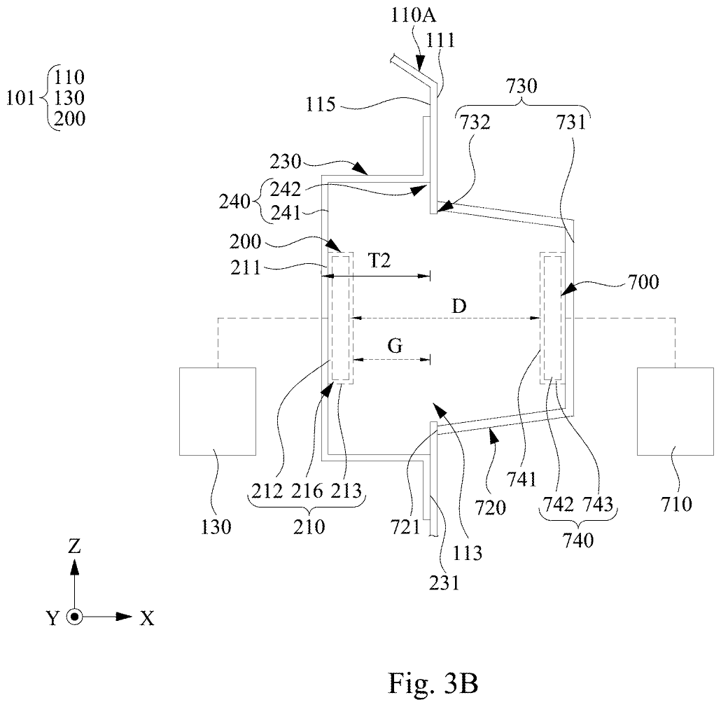

FIG. 3A is a perspective view shown a power receiving module 200 and a first cover 230 according to one embodiment of the present disclosure. FIG. 3B is a schematic side view of the power receiving module 200 of FIG. 3A docking to a power transmission module 700. As shown in FIG. 3A and FIG. 3B, the mobile carrier 101 of the present embodiment is substantially the same to the above-mentioned mobile carrier 100, and the difference therebetween is that, the recessed portion is a first cover 230 containing a first recess 240, and is not integrally formed on the case 110A, but one surface 231 of the first cover 230 being additionally combined with an inner surface 115 of the case 110A. In this embodiment, the opening 113 is provided through the case 110A (FIG. 3B). The first recess 240 is recessed on a side of the first cover 230 facing towards the opening 113. The first cover 230 is located within the case 110A, connected to the case 110A to cover the opening 113, so that the opening 113 is connected to the first recess 240 formed within the first cover 230.

More specifically, the first recess 240 includes a trough bottom 241 and a notch 242 opposite to each other, and the notch 242 is closer to the opening 113 than the trough bottom 241. The first coil device 210 is located within the first recess 240 and fixed on the trough bottom 241 of the first recess 240. A front surface of the first coil device 210 (referred to induction surface 211 hereinafter) faces towards the notch 242. In addition, the thickness T2 of the first cover 230 is about 10 cm, and the gap G between the first coil device 210 and the opening 113 is about 8 cm.

In this embodiment, the first cover 230 and the second cover 720 are collectively integrated into a shielding chamber containing an induction space therein. Therefore, the shielding chamber can provide isolation between the induction space and the externals, so that the first coil device 210 and the second coil device 740 in the induction space can be shielded by the shielding chamber, so that the electromagnetic waves in the induction space will not be leaked outwardly from the shielding chamber. For example, the first cover 230 and the second cover 720 are respectively made of metal.

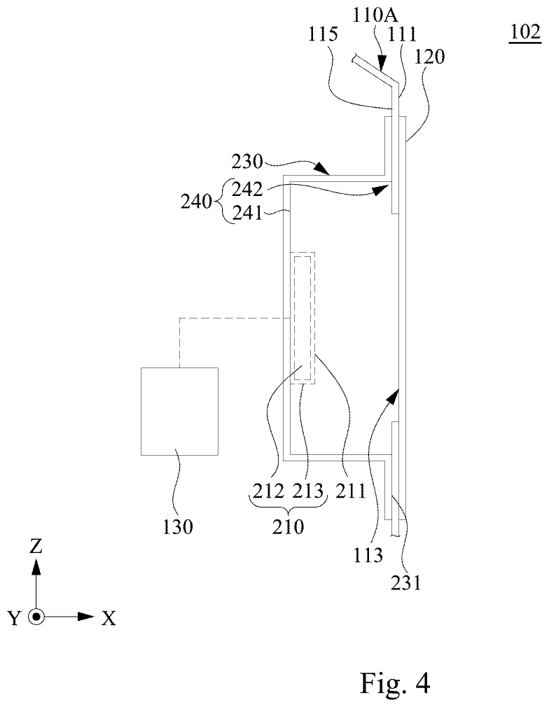

FIG. 4 is a partially schematic view of a mobile carrier 101 according to one embodiment of the present disclosure. As shown in FIG. 4, the mobile carrier 102 of the present embodiment is substantially the same to the one in FIG. 3B, and the difference therebetween is that, the mobile carrier 102 further includes a lid element 120 covering the case 110A and the opening 113. More specifically, the lid element 120 is fixed on the outer surface 111 of the case 110A to cover the opening 113 and the outer surface 111 of the case 110A.

It is noted that since the lid element 120 is made of non-metallic material, that is, the lid element 120 includes non-metallic material, thus, the lid element 120 disposed between the first cover 230 and second cover 720 (refer to FIG. 3B) does not affect the induction of the first coil device 210 to the second coil device 740. It is noted, in this embodiment, the lid element 120 is an exterior decorative panel on the electric vehicle, however, the disclosure is not limited thereto, and in other embodiments, the lid element 120 may also be a license plate or an advertising brand of electric vehicles.

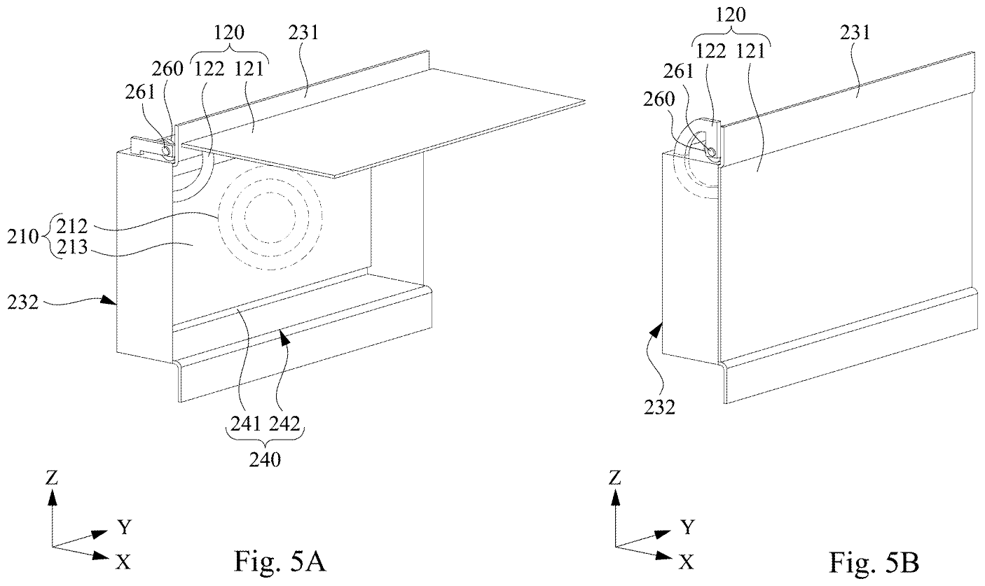

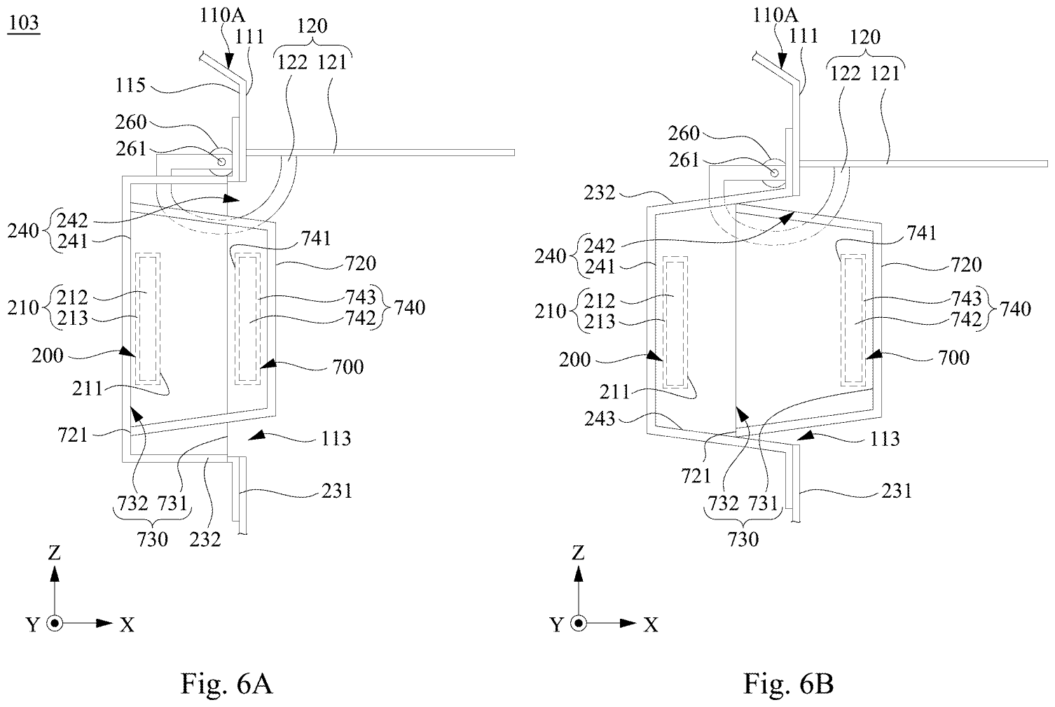

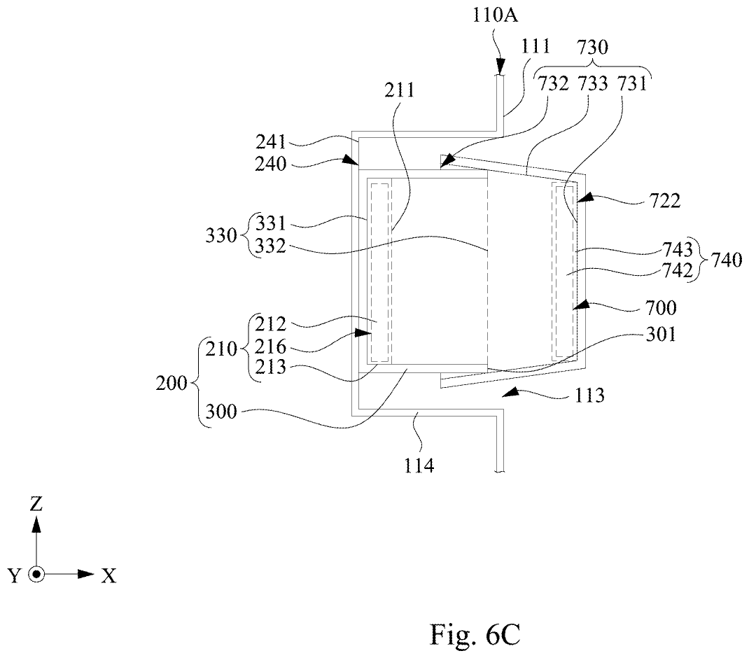

FIG. 5A and FIG. 5B are perspective views respectively shown a first cover 232 containing a power receiving module 200 in different states according to one embodiment of the present disclosure. FIG. 6A is a schematic view shown a power receiving module 200 and a power transmission module 700 which are docked to each other according to one embodiment of the present disclosure. The mobile carrier 103 of the present embodiment is substantially the same to the one in FIG. 4, and the difference therebetween is that, as shown in FIG. 5A and FIG. 5B, the lid element 120 is movable to cover the opening 113 of the case 110A, or expose the opening 113 of the case 110A (refer to FIG. 6A).

More specifically, as shown in FIG. 5A and FIG. 5B, in this embodiment, the lid element 120 includes a lid plate 121 and a linkage portion 122 connected to the lid plate 121. The lid plate 121 movably covers the opening 113. The mobile carrier 103 further includes a first motor device 260. The first motor device 260 is connected to the linkage portion 122 for moving the lid plate 121 to cover and expose the opening 113 through the linkage portion 122 (refer to FIG. 6A).

In addition, in this embodiment, for example, the first motor device 260 is located on the first cover 232, and the first motor device 260 is located outside the first recess 240, however, the disclosure is not limited thereto. The linkage portion 122 is arc-shaped, and one end of the linkage portion 122 is pivotally connected to a transmission shaft 261 of the first motor device 260, and the other end extends into the first recess 240 to be fixedly connected to the lid plate 121 through the notch 242 of the first recess 240 and the opening 113, however, the present disclosure is not limited thereto.

It is noted, in this embodiment, the lid element 120 is an exterior trim panel on the electric vehicle, however, the disclosure is not limited thereto, and in other embodiments, the lid element 120 may also be a license plate or an advertising brand of electric vehicles.

As shown in FIG. 6A, when the first cover 232 docks to the second cover 720, the second cover 720 extends into the first recess 240 to be in direct contact with the trough bottom 241 of the first recess 240. More specifically, in this embodiment, the trough bottom 241 of the first recess 240 is planar, and the surface 721 of the second cover 720 is also planar.

Thus, when the first cover 232 docks to the second cover 720, the second cover 720 is located within the first recess 240, and the surface 721 of the second cover 720 directly contacts the first recess 240. The entire of the second recess 730 is the aforementioned induction space, and both the first coil device 210 and the second coil device 740 are located within the second recess 730. It is noted, under other requirements and constraints, as long as a certain distance kept between the first coil device 210 and the second coil device 740, the above structure of this embodiment can achieve the first coil device 210 and the second coil device 740 being closer to each other, thereby improving the induction performance.

FIG. 6B is a schematic view shown a power receiving module 200 and a power transmission module 700 which are docked to each other according to one embodiment of the present disclosure. As shown in FIG. 6B, the docking state of the power receiving module 200 and the power transmission module 700 of the present embodiment is substantially the same to the docking state in FIG. 6A, and the difference therebetween is that, when the first cover 232 docks to the second cover 720, the second cover 720 extends into one part of the first recess 240 but not in direct contact with the trough bottom 241 of the first recess 240. More specifically, in this embodiment, the first recess 240 further includes a plurality of inner sloped surfaces 243. The inner sloped surfaces 243 collectively surround and adjoin to the trough bottom 241 of the first recess 240 at one side, and collectively surround to form the notch 242 of the first recess 240 at the other side. Thus, when the first cover 232 docks to the second cover 720, one part of the second cover 720 extends into the first recess 240 to be in contact with the inner sloped surface 243 of the first recess 240 and stopped moving forward by the inner sloped surface 243. Thus, one part of the first recess 240 and the entire of the second recess 730 are collectively integrated to be the aforementioned induction space.

FIG. 6C is a schematic view shown a power receiving module and a power transmission module which are docked to each other according to one embodiment of the present disclosure. As shown in 6C, the docking state of the power receiving module 200 and the power transmission module 700 of the present embodiment is substantially the same to the docking state in FIG. 2, and the difference therebetween is that, the power receiving module 200 further includes a third cover 300 for loading the first coil device 210. The third cover 300 is located at the trough bottom 241 of the first recess 240. One surface 301 of the third cover 300 facing towards the opening 113 is recessed with a third recess 330. The third recess 330 includes a trough bottom 331 and a notch 332 which are opposite to each other. The notch 332 of the third recess 330 is closer to the opening 113 than the trough bottom 331, and the trough bottom 331 of the third recess 330 is closer to the trough bottom 241 than the opening 113. The first coil device 210 is located within the third recess 330 and fixed on the trough bottom 331 of the third recess 330, and the front surface of the first coil device 210 (referred to induction surface 211 hereinafter) faces towards the notch 332. More specifically, in this embodiment, the second recess 730 further includes a plurality of inner sloped surfaces 733, and the inner sloped surfaces 733 collectively surround and adjoin to the trough bottom 731 of the second recess 730 at one side, and collectively surround to form the notch 732 at the other side.

Thus, when the third cover 300 docks to the second cover 722, one part of the second cover 722 extends into the first recess 240, and one part of the third cover 300 extends into the second recess 730, and the third cover 300 is in contact with the inner sloped surface 733 of the second recess 730 and stopped moving forward by the inner sloped surface 733. Thus, one part of the second recess 730 and the entire of the third recess 330 are collectively integrated to be the aforementioned induction space.

It is noted, under other requirements and constraints, as long as a certain distance is kept between the first coil device 210 and the second coil device 740, the above structure of this embodiment can achieve the dynamic adjustment to the gap between the first coil device 210 and the second coil device 740, thereby meeting the appropriate induction performance.

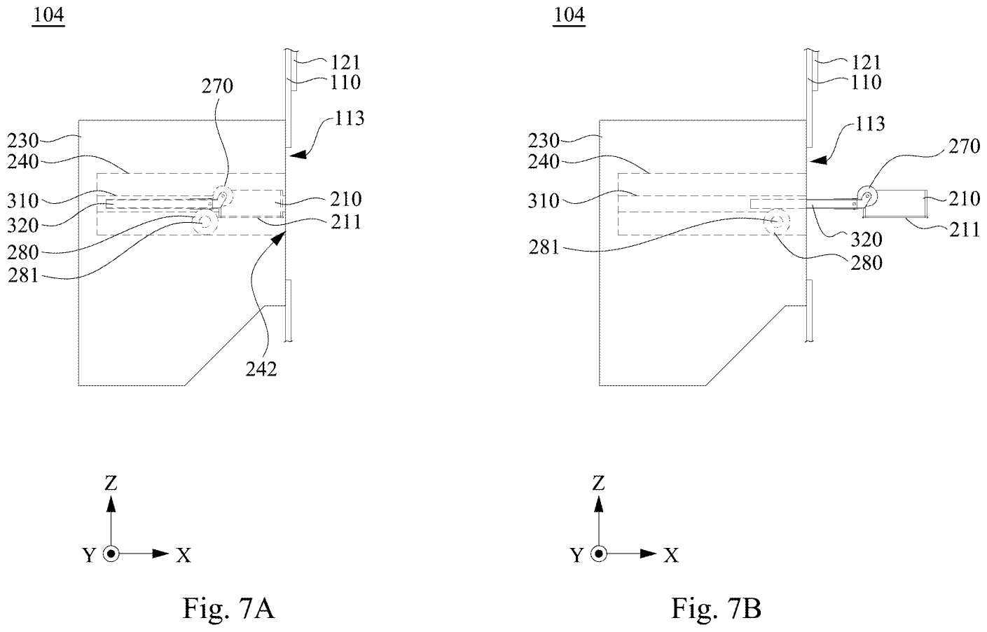

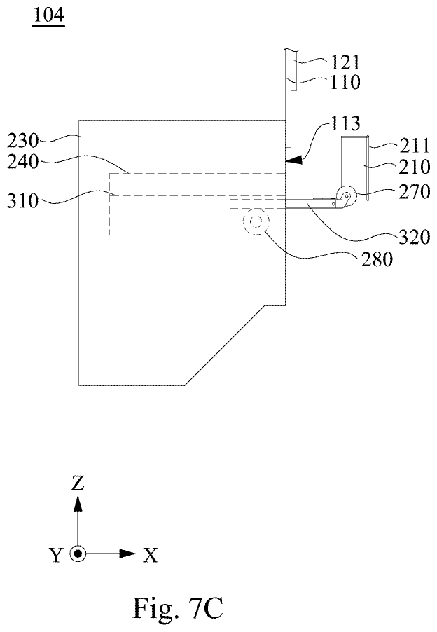

FIG. 7A to FIG. 7C are continuous operational schematic views of a mobile carrier 104 according to one embodiment of the present disclosure. As shown in FIG. 7A, the mobile carrier 104 of the present embodiment is substantially the same to the mobile carrier 101 in FIG. 3A, and the difference therebetween is that, the first coil device 210 is able to move out of the first cover 230 or back into the first cover 230, rather than statically disposed within the first cover 230, and the lid plate 121 is linearly movable to cover or expose the opening 113 in a gravity direction (e.g., Z axis, FIG. 7A).

More specifically, the mobile carrier 104 further includes at least one first rail 310, at least one first bracket 320, a second motor device 270 and a third motor device 280. The first rail 310 is fixedly disposed within the first cover 230, and the first rail 310 is provided with a first long axis direction (e.g., X axis) that is parallel to the long axis direction (e.g., X axis) of the first recess 240. The first bracket 320 is slidably disposed on the first rail 310 for linearly sliding in the first long axis direction (e.g., X axis). The second motor device 270 is fixedly connected to the first bracket 320, and the second motor device 270 has a transmission shaft (not shown in figures) coaxially connected to the first coil device 210 for rotating the first coil device 210 about a rotary axis (e.g., Y axis). The rotary axis (e.g., Y axis), the first long axis direction (e.g., X axis) and the gravity direction (e.g., Z axis) are orthogonal to one another. The third motor device 280 is disposed within the first cover 230, and connected to the first bracket 320 for moving the first bracket 320 to linearly slide along the first rail 310.

Therefore, as shown in FIG. 7A and FIG. 7B, when the first bracket 320 slides along the first rail 310 so as to move the second motor device 270 and the first coil device 210 out of the first recess 240 from the opening 113. At this moment, the first long axis direction (e.g., Z axis) of the first coil device 210 is parallel to the gravity direction (e.g., Z axis), that is, the induction surface 211 of the first coil device 210 faces downward. The current arrangement direction of the first coil device 210 is referred to a lying situated state hereinafter; next, as shown in FIG. 7B to FIG. 7C, after the second motor device 270 and the first coil device 210 are moved outside the carrier body 110, the second motor device 270 rotates the first coil device 210 so that the first coil device 210 is rotated about the rotary line (e.g., Y axis) to achieve the first axis line (e.g., X axis) of the first coil device 210 to be parallel to the first long axis direction (e.g., X axis), in other words, the induction surface 211 of the first coil device 210 is changed into the horizontally situated state from the lying situated state so as to be able to face the second coil device 740 (FIG. 1).

It is noted, in the embodiment, although the transmission shaft of the second motor device 270 is connected to the lateral side of the first coil device 210, however, the disclosure is not limited thereto, the transmission shaft of the second motor device 270 can be connected to a middle position of the side of the first coil device 210 according to other requirements and constraints in other embodiments.

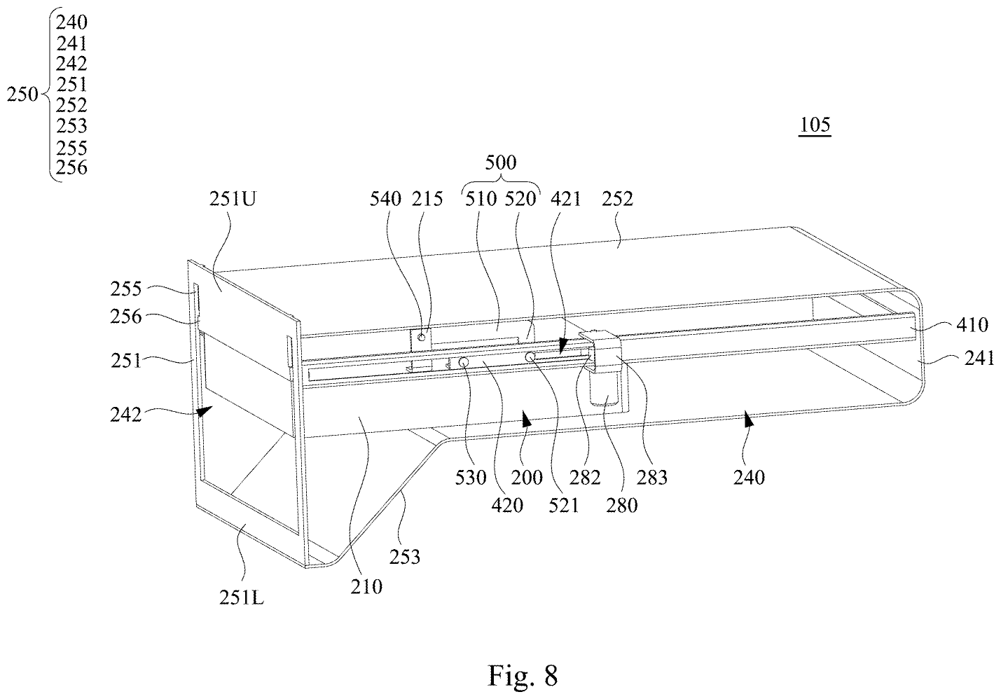

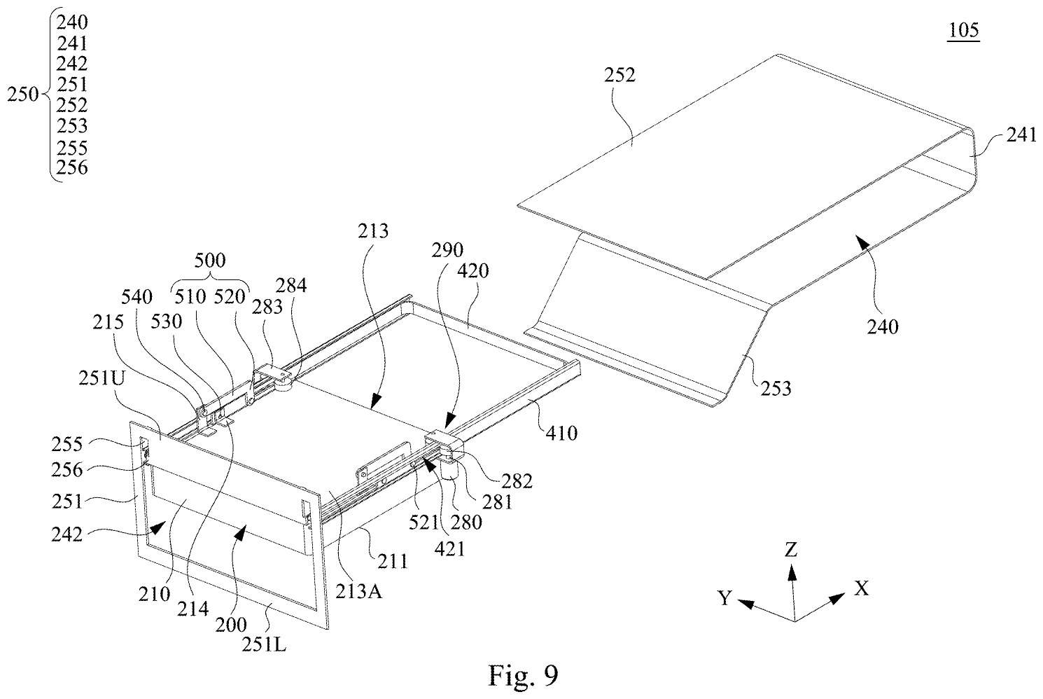

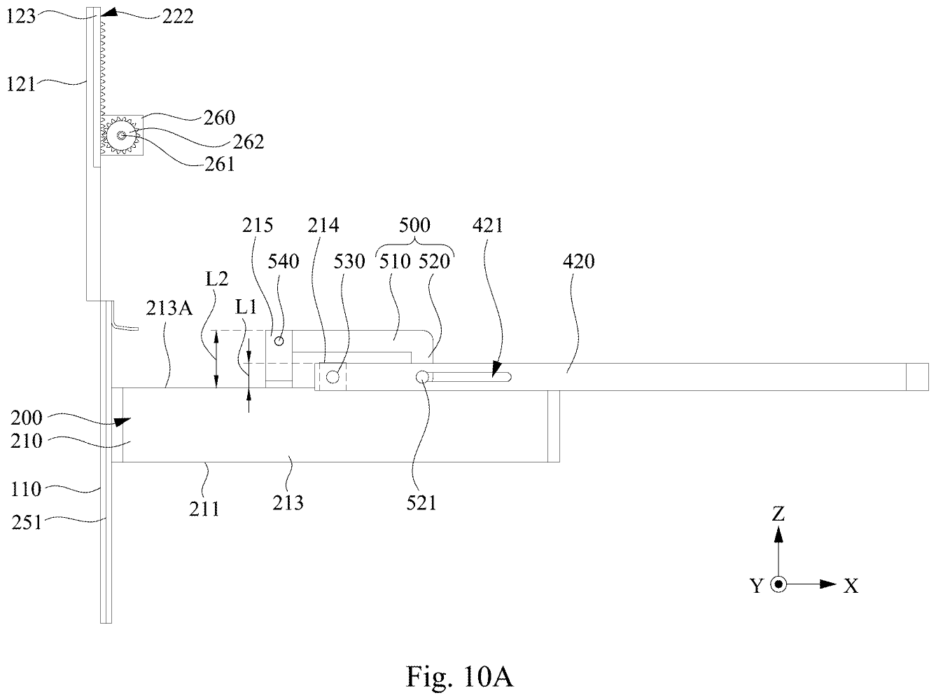

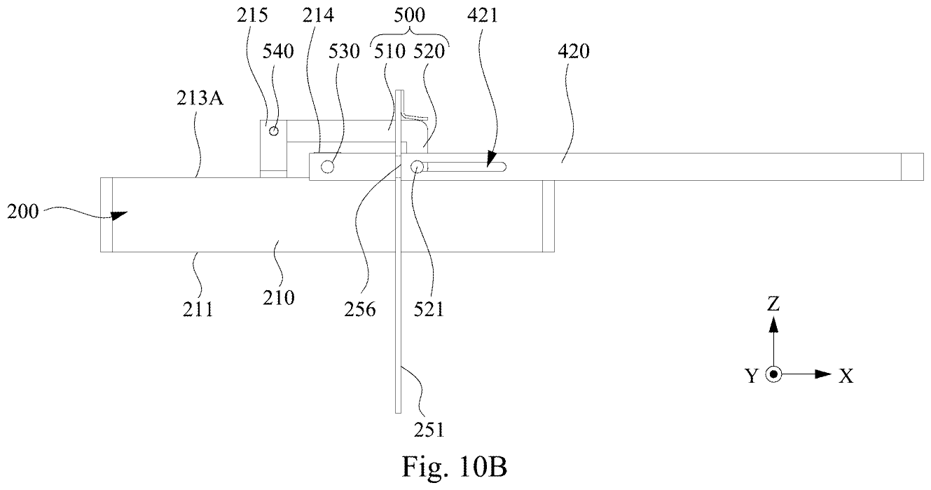

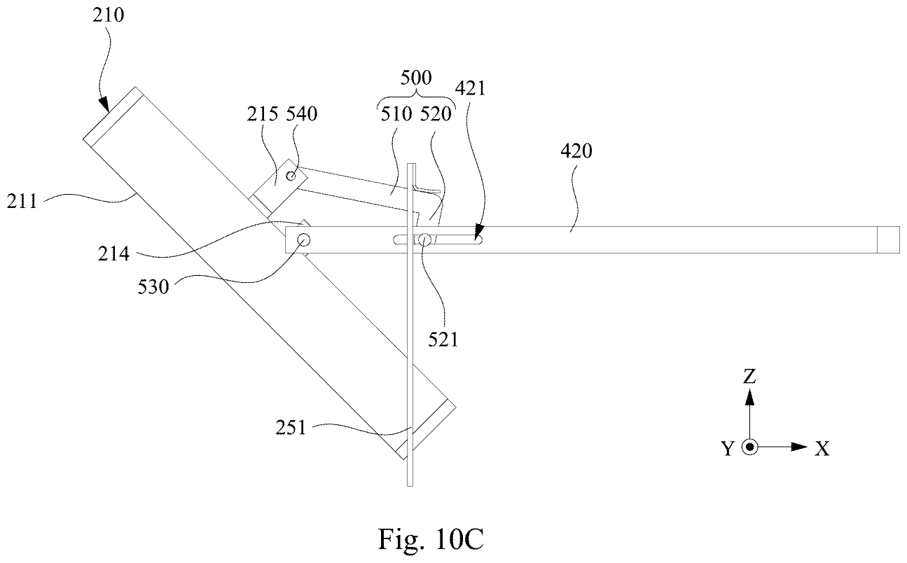

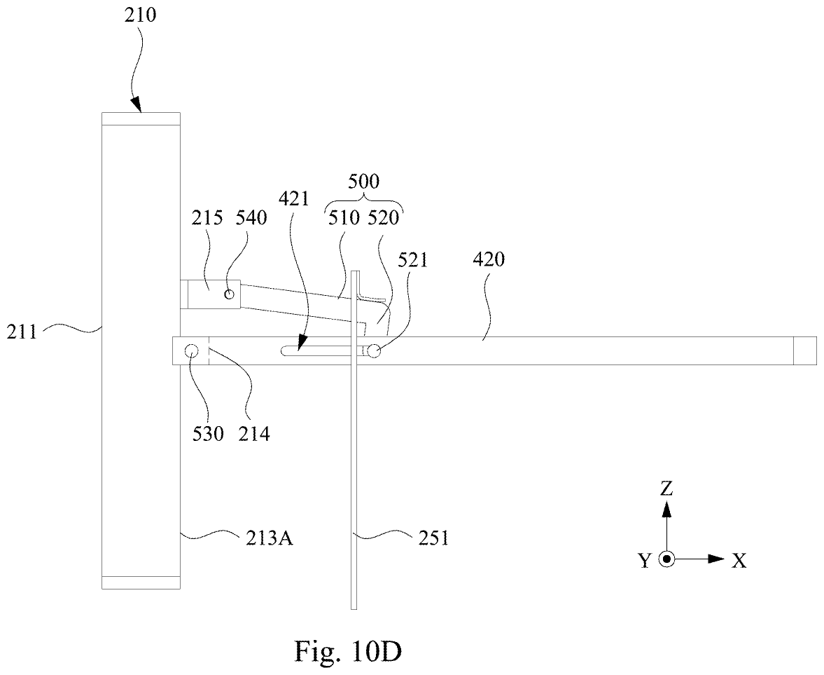

FIG. 8 is a perspective view shown a power receiving module 200 and a first cover 250 according to one embodiment of the present disclosure. FIG. 9 is a partially disassembled view of the power receiving module 200 and the first cover 250 in FIG. 8. FIG. 10A to FIG. 10D are continuous operational schematic views of the power receiving module 200 of FIG. 9. As shown in FIG. 8 to FIG. 9, the power receiving module 200 of this embodiment can alter the first coil device 210 into the lying situated state (FIG. 10A) from the horizontally situated state (FIG. 10D) without using a kinetic device (e.g., motor device).

More particularly, as shown in FIG. 8 and FIG. 9, the mobile carrier 105 further includes one or more (e.g., two) stoppers 256. The stoppers 256 are disposed on the mobile carrier 105 (e.g., first cover 250). The first coil device 210 includes one or more (e.g., two) first shaft-received portions 214 and one or more (e.g., two) second shaft-received portions 215. The first shaft-received portions (e.g., L-shaped curved portion) 214 and the second shaft-received portions (e.g., L-shaped curved portion) 215 are commonly disposed on the surface 213A of the first coil housing 213, and each of the second shaft-received portions 215 is disposed between one of the first shaft-received portions (e.g., L-shaped curved portion) 214 and one of the stoppers 256, and the height L1 of the first shaft-received portion 214 is smaller than the height L2 of the second shaft-received portion 215.

More particularly, the first shaft-received portions 214 are symmetrically located on the surface 213A of the first coil housing 213, that is, the first shaft-received portions 214 are arranged in the Y axis, and the second shaft-received portions 215 are symmetrically located on the surface 213A of the first coil housing 213, that is, the second shaft-received portions 215 are arranged in the Y axis. The second shaft-received portions 215 are aligned with the stoppers 256, respectively. However, the present disclosure is not limited thereto, and in other embodiments, the stopper 256 may also be located on the carrier body.

The mobile carrier 105 further includes one or more (e.g., two) second rails 410, at least one (e.g., one) second bracket 420, at least one (e.g., two) L-shaped linkage elements 500 and at least one (e.g., two) sliding elements 521. The second rails 410 are fixed within the first cover 250, and each of the second rails 410 is provided with a second long axis direction (e.g., X axis) that is parallel to the opening direction (e.g., X axis) of the aforementioned notch 242. The second bracket 420 (e.g., U type) is slidably disposed on the second rails 410 and pivotally connected to the first shaft-received portion 214 through a first pivot 530. The second bracket 420 is formed with an elongated hole 421, and the long axis direction of the elongated hole 421 is parallel to the second long axis direction (e.g., X axis). The L-shaped linkage element 500 includes a first section 510 and a second section 520 which are intersected each other. The first section 510 is pivotally connected to the second shaft-received portion 215 through a second pivot 540, and parallel to the second long axis direction (e.g., X axis). The second section 520 extends towards the second shaft-received portion 215 from the first section 510. The sliding element 521 is disposed on the second section 520 of the L-shaped linkage element 500 and slidably limited within the elongated hole 421.

Therefore, as shown in FIG. 10A and FIG. 10B, when the second bracket 420 pushes one part of the first coil device 210 out of the notch 242 (or the opening 113) through the first pivot 530 in the second long axis direction (e.g., X axis, refer to FIG. 8), the L-shaped linkage element 500 is stopped extending outwards from the notch 242 by the stoppers 256 (refer to FIG. 8). At this moment, when the first coil device 210 is disposed within the first cover 250, the first axis line of the first coil device 210 is parallel to the gravity direction (e.g., Z axis), that is, the first coil device 210 is in the lying situated state (FIG. 10A). Next, as shown in FIG. 10C and FIG. 10D, when the second bracket 420 continues to push the first coil device 210, the sliding elements 521 start to slide in a direction facing away from the first pivot 530, and the first coil device 210 (i.e., the rest part of the first coil device 210) is rotated out of the first cover 250 from the notch 242 with the second pivot 540 as a fulcrum (refer to FIG. 8) so that the first axial line of the first coil module 212 is parallel to the second long axis direction (e.g., X axis), that is, the first coil device 210 is in the horizontally situated state (FIG. 10D).

More specifically, in this embodiment, the first cover 250 further includes a front side plate 251, a U-shaped frame 252 and a lower inclined plate 253. The front side plate 251 is connected to the carrier body 110 (FIG. 3B). One side of the U-shaped frame 252 is connected to the upper side 251U of the front side plate 251, and the lower inclined plate 253 is respectively connected to the other side of the U-shaped frame 252 and the lower side 251L of the front side plate 251. The front side plate 251 further includes two slits 255. The notch 242 is aligned with and connected to the aforementioned opening 113 (refer to FIG. 5A). The slits 255 are symmetrically formed on the front side plate 251, and respectively connected to the same side of the notch 242. Each of the stoppers 256 is located on an inner side of one of the slits 255 for preventing the corresponding L-shaped linkage elements 500 from continuing to move so as not to extend out of the first cover 250 from the slits 255.

In this embodiment, the mobile carrier 105 further includes at least one transmission mechanism 290. For example, the transmission mechanism 290 includes a third motor device 280, a driving roller 282, a connecting frame 283 and a driven roller 284. The third motor device 280 is located within the first cover 250, fixed on the second rails 410, and linked with the second bracket 420 for moving the second bracket 420 to slide linearly along the second long axis direction (e.g., X axis). The connecting frame 283 is fixedly connected to the second rails 410, accommodates the driving roller 282 therein, and allows the driven roller 284 to be rotatably disposed on the connecting frame 283. The driving roller 282 is coaxially connected to the transmission shaft 281 of the third motor device 280 and in direct contact with the second bracket 420. The second bracket 420 is sandwiched between the driving roller 282 and the driven roller 284.

In this way, when the transmission shaft 281 of the third motor device 280 rotates the driving roller 282 synchronously, the driving roller 282 can give way to the second bracket 420 between the driven roller 284 and the driving roller 282 to slide synchronously and linearly. However, as long as the second bracket 420 can slide linearly, the present disclosure is not limited to the above structure.

In addition, in this embodiment, as shown in FIG. 10A, the first motor device 260 can drive the lid plate 121 to be slid linearly in the direction of gravity (e.g., Z axis). More specifically, for example, the linkage portion 122 includes a toothed rack 123 fixedly located on one surface of the lid plate 121, and the long axis direction of the toothed rack 123 is parallel to the direction of gravity (e.g., Z axis). The first motor device 260 further includes a gear 262 coaxially connected to the transmission shaft 261 of the first motor device 260 and directly engaged with the toothed rack 123. Therefore, when the transmission shaft 261 of the first motor device 260 rotates the gear 262 synchronously, the gear 262 can linearly move the lid plate 121 synchronously through the toothed rack 123. However, as long as the lid plate 121 can slide linearly, the disclosure is not limited to the above structure.

It is noted, the mobile carrier described in these embodiments may be an autonomous mobile carrier or a driver-controlled mobile carrier, however, the present disclosure is not limited thereto.

Thus, through the construction of the embodiments above, the disclosure is able to accomplish a coil device being installed without affecting the appearance of the vehicle body of electric vehicle so as to reduce the risk of theft and hindering the appearance, thereby increasing the user's purchase intention.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure covers modifications and variations of this disclosure provided they fall within the scope of the following claims and their equivalents.

What is claimed is:

1. A mobile carrier, comprising:
a carrier body formed with a recessed portion and an opening being in communication with to the recessed portion;
a power storage device disposed within the carrier body; and
a power receiving module comprising:
a first coil device electrically connected to the power storage device and received within the recessed portion, wherein a gap is defined between the first coil device and the opening.

2. The mobile carrier of claim 1, wherein the carrier body comprises a case, and the recessed portion is recessed on the case, and the opening is arranged on one side of the recessed portion that is connected to the case.

3. The mobile carrier of claim 1, further comprising:
a lid element comprising a lid plate covering the opening.

4. The mobile carrier of claim 3, wherein the lid element further comprises a linkage portion that is connected to the lid plate, and the lid plate movably covers the opening; and
the carrier body further comprises a first motor device connected to the linkage portion so as to move the lid plate through the linkage portion.

5. The mobile carrier of claim 1, wherein the carrier body further comprises:
at least one rail fixed within the recessed portion;
at least one bracket slidably disposed on the at least one rail and linearly sliding through the opening; and
a second motor device fixedly connected to the at least one bracket, and having a transmission shaft connected to the first coil device for rotating the first coil device.

6. The mobile carrier of claim 1, wherein the first coil device comprises:
a coil module; and
a coil housing received within the recessed portion and formed with an accommodating recess for accommodating the coil module.

7. The mobile carrier of claim 6, further comprising:
at least one stopper disposed on the carrier body;
the first coil device further comprising at least one first shaft-received portion and at least one second shaft-received portion, the at least one first shaft-received portion and the at least one second shaft-received portion being commonly disposed on a same surface, wherein when the first coil device is disposed in the recessed portion, an axial line of the coil module and a gravity direction are parallel to each other; and
the carrier body further comprising:
at least one rail fixed within the recessed portion;
at least one bracket slidably disposed on the at least one rail and pivotally connected to the at least one first shaft-received portion through a first pivot, and the at least one bracket that is formed with an elongated hole;
at least one L-shaped linkage element comprising a first section and a second section which are intersected each other, the first section pivotally connected to the at least one second shaft-received portion through a second pivot, and the second section extending towards the at least one second shaft-received portion from the first section; and
a sliding element disposed on the second section of the at least one L-shaped linkage element and slidably limited within the elongated hole,
wherein when the bracket pushes a part of the first coil device out of the opening through the first pivot, the at least one L-shaped linkage element is stopped by the at least one stopper, when the bracket continues to push the first coil device, the first coil device uses the second pivot as a fulcrum to rotate the first coil device out of the recessed portion from the opening, so that the axial line of the coil module and the gravity direction are orthogonal to each other.

8. The mobile carrier of claim 1, wherein the first coil device is electrically connected to the power storage device through a power cord penetrating through the recessed portion.

9. The mobile carrier of claim 1, wherein an opening direction of the opening and a gravity direction are orthogonal to each other.

10. A wireless charging system, comprising:
the mobile carrier of claim 1, wherein the recessed portion is formed with a first recess;
a cover formed with a second recess at one surface of the cover; and
a power transmission module comprising a power supply device and a second coil device disposed within the second recess and electrically connected to the power supply device,
wherein when the cover docks to the recessed portion, an induction space is defined between the recessed portion and the second recess of the cover, and the first coil device and the second coil device are faced and induced to each other in the induction space.

11. The wireless charging system of claim 10, wherein when the cover is in contact with the carrier body to cover the opening, the first recess and the second recess of the cover are in communication with each other for integrating the induction space.

12. The wireless charging system of claim 10, wherein the first recess is formed with a trough bottom therein, and the trough bottom is in a planar shape, wherein when the cover docks to the recessed portion, the cover is disposed within the first recess, the cover is in contact with the trough bottom of the first recess and covers the first coil device.

13. The wireless charging system of claim 10, wherein the first recess is formed with a trough bottom and an inner sloped surface adjoined to the trough bottom, wherein when the cover docks to the recessed portion, one part of the cover is disposed within the first recess, and the cover is in contact with the inner sloped surface of the first recess.

14. The wireless charging system of claim 10, wherein the power receiving module further comprises another cover which is capable of loading the first coil device and disposed within the first recess; and
the second recess is formed with a trough bottom and an inner sloped surface adjoined to the trough bottom,
wherein when the cover docks to the recessed portion, one part of the cover is disposed within the first recess, one part of the another cover is disposed within the second recess, and the another cover is in contact with the inner sloped surface of the second recess.

15. The wireless charging system of claim 10, wherein the recessed portion and the cover are collectively integrated into a shielding chamber containing the induction space therein.
